(19) United States
(12) Patent Application Publication
(10) Pub. No.: US 2005/0097024 A1
(43) Pub. Date: May 5, 2005

(54) Multi-party bidding for online advertising space

(76) Inventor: Jim E. Rainey, Mountain View, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/698,497

(22) Filed: Oct. 30, 2003

(51) Int. Cl. G06F 17/30; G06F 17/60

(52) U.S. Cl. 705/37; 707/3

(57) ABSTRACT

In one embodiment, the invention provides a method, comprising allowing primary bidders to each place a primary bid for displaying an associated advertisement within a results page of a search based on a search string; and allowing a secondary bidder to selectively place a secondary bid to augment the primary bid of a primary bidder by a monetary amount.

### FIELD OF THE INVENTION

This invention relates to online advertising using a Wide Area Network (WAN), such as the Internet. In particular, the invention relates to bidding for online advertising space.

### BACKGROUND

Online advertising has evolved to the point where advertisers are able to bid to have their advertisements included in a results page of an online search. For example, search engines such as Google and Overture provide a user interface (UI) whereby an advertiser can bid for an advertisement to be associated with a particular search string or keyword combination, e.g., “digital camera.” Thus, when the search string, e.g. “digital camera” is entered as part of an online search, the advertisement is displayed with a results page for the search. Various methodologies exist to rank or order the advertisements from different advertisers within the results page. However, the bidding is still on a keyword basis. As used herein, the term “keyword” includes user input search strings as well as subject or category search terms that form the basis of a search when the user selects a particular subject or category from an online catalogue.

The current user interfaces for advertisers allow a party to enter a keyword combination (search string) of interest; e.g., “notebook computer” and to enter a bid amount that the party is prepared to pay for the associated advertisement to be with the search result. In order to assist the party to determine the bid amount, in some cases the UIs indicate the current ranking the associated advertisement based on the bid amount. In other cases the UIs show the maximum bid for a given search string. Thus, the party can increase or decrease the bid amount to influence or achieve the desired ranking.

Value chains refer to the various parties that add value to a particular product or service, either by creating the product or service, by contributing components to it, or by enhancing the product or service in some way. An example of a value chain would be the manufacturer of an article for manufacture, a distributor of the article, and the bidding retailer who retailed the article to the public.

One problem with the above-described online advertising techniques is that they only allow a single bidding party per placement or advertisement, and thus do not allow all parties in the value chain to work together to determine the outcome of the bidding.

### BRIEF DESCRIPTION OF THE DRAWINGS

FIGS. 1 and 4 show flowcharts of operations performed in accordance with one embodiment of the invention;

FIGS. 2 and 3 show examples of user interfaces generated in accordance with one embodiment of the invention; and

FIG. 5 shows a high level block diagram of a system in accordance with one embodiment of the invention.

### DETAILED DESCRIPTION

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Embodiments of the present invention disclose techniques to allow multiple bidding parties to bid for advertisement placement. One advantage of the present invention is that it allows real world value chains to determine the outcome of the bidding. For example, a manufacturer and retailer may combine their bids in order to influence the outcome of the bidding, as will be described below.

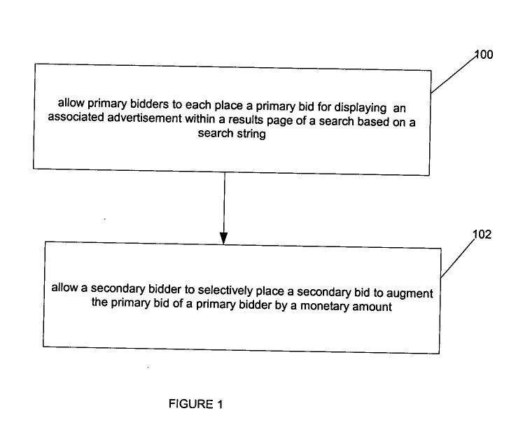

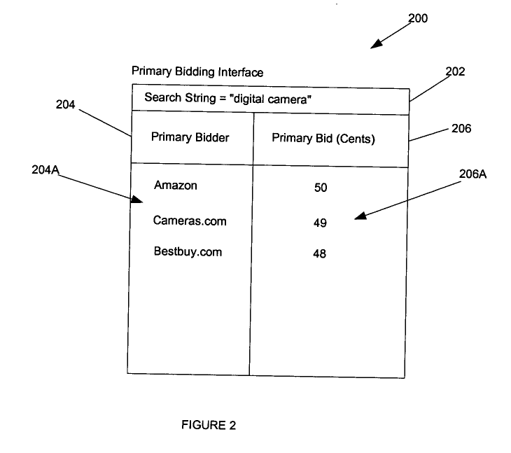

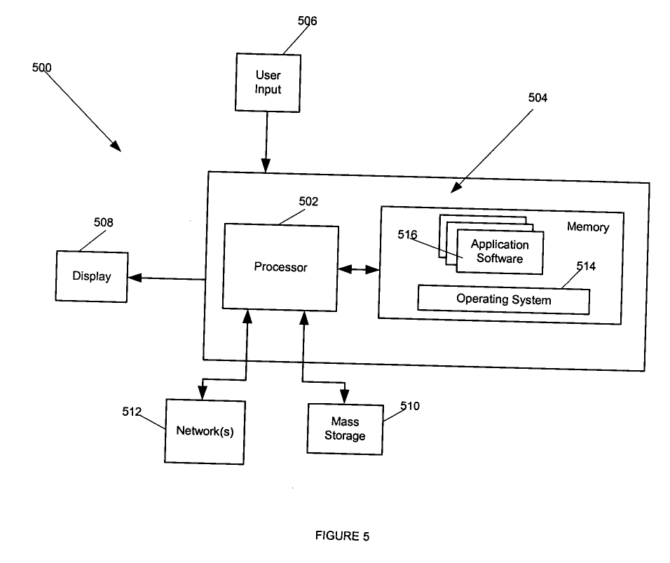

FIG. 1 of the drawings illustrates a method, in accordance with one embodiment, performed by a system, such as a system 500 shown in FIG. 5 of the drawings. Referring to FIG. 1, at block 100 primary bidders are allowed to each place a primary bid for displaying an associated advertisement within an results page of a search based on a search string. More particularly, each primary bid comprises a monetary amount that bidder is willing to pay for a particular action. The particular action may be a cost-per-acquisition (also known as a cost-per-buy, a cost-per-sale, a cost-per-download), a cost-per-click, or a cost-per-lead. The operations performed at block 100 of FIG. 1 are best described with reference to the primary bidding interface 200 shown in FIG. 2 of the drawings. The primary bidding interface 200 is generated by the system 500 of FIG. 5 and is displayed, for example, on a browser of a computer system of a primary bidder. As will be seen, the primary bidding interface includes a block 202 within which a search string in respect of which bids are being placed is displayed. In the example shown in FIG. 2, the search string is the string “digital camera.” The primary bidding interface 200 includes a column 204 that displays the current primary bidders for the search string shown in block 202. In FIG. 2, the current primary bidders are indicated by reference numeral 204A. The primary bidding interface 200 also includes a primary bid column 206, wherein the actual bid amounts in cents are displayed. In FIG. 2, the primary bid amounts is indicated by reference numeral 206A. The information in the primary bidding interface 200 indicates that a primary bidder “Amazon” has bid fifty cents (0.50¢), a primary bidder “Cameras.com” has bid forty-nine cents (0.49¢), and a primary bidder “BestBuy.com” has bid forty-eight cents (0.48¢). Each of the bids are in respect of the search string “digital camera.” Each of the primary bidders will have an advertisement associated with the search string “digital camera,” which associated advertisement is to be displayed or included within a results pages generated by a search engine using the search string “digital camera.” Each of the primary bidders are bidding for the “placement” or “inclusion” of their respective associated advertisements within the results page. All things being equal, since Amazon has bid the most for the search string “digital camera,” it is to be expected that the advertisement associated with Amazon would be placed first within the results of the search. The advertisement associated with Cameras.com would be placed second, and the advertisement associated with BestBuy.com will be placed third.

Referring again to FIG. 1 of the drawings, at block 102, a second re-bidder is allowed to selectively place a secondary bid to augment the primary bid of a primary bidder by a monetary amount. Typically the secondary bidder is someone who has an interest in augmenting or boosting the primary bid of a primary bidder. For example, the primary bidders and the secondary bidders may form real world value chains. In order to explain the notion of a real world value chain, for purposes of this description, the secondary bidder is assumed to be a digital camera manufacturer, for example Canon Incorporated. Each of the primary bidders shown in the primary bidding interface 200 of FIG. 2 are digital camera retailers. For purposes of this description, it is assumed that Canon Incorporated is a secondary bidder wishing to boost or augment the primary bid of BestBuy.com. There could be a variety of reasons why a manufacturer such as Canon Incorporated would wish to boost the primary bid of a retailer such as BestBuy.com. One reason why a manufacturer would wish to boost the primary bid of a retailer may be that the retailer has contractually undertaken to retail a high volume of the manufacturer's products and the manufacturer may wish to assist the retailer in securing the highest rank position of the retailers associated advertisement within the results of a search. For example, the manufacturer Canon Incorporated may wish to promote a specific model of a digital camera that the retailer/primary bidder BestBuy.com has undertaken to sell a large quantity of. Thus, Canon Incorporated may have an interest in ensuring that BestBuy.com's associated advertisement ranks highly within the result of a search based on the search string “Digital Camera.”

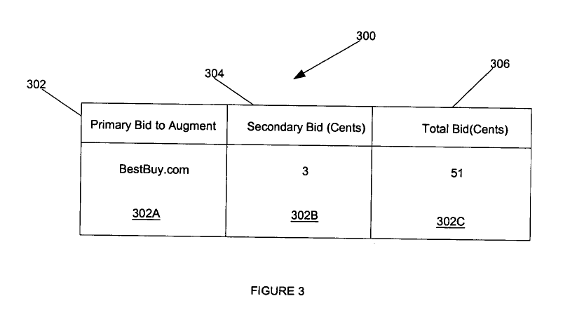

In order to assist the secondary bidder with a placement of a secondary bid, the system 500 displays a user interface (UI) 300, shown in FIG. 3 of the drawings. Referring to FIG. 3, it will be seen that the UI 300 includes a column 302 in which the primary bid that is to be augmented is identified. The UI 300 also includes a column 304 in which the secondary bid amount is specified, and a column 306 in which a total bid is displayed. The total bid is calculated as the sum of the primary bid and the secondary bid. In the case of the example shown in FIG. 3, the primary bid that is augmented is the bid of BestBuy.com which is indicated by reference numeral 302A, the secondary bid amount 302B is three cents (0.03¢), and the total bid 302C is fifty-one cents (0.51 ¢). Since the total bid is now greater than the primary bid of Amazon, all things being equal, the bid of BestBuy.com is a winning bid and therefore the advertisement associated with BestBuy.com will rank highest within a result of a search page.

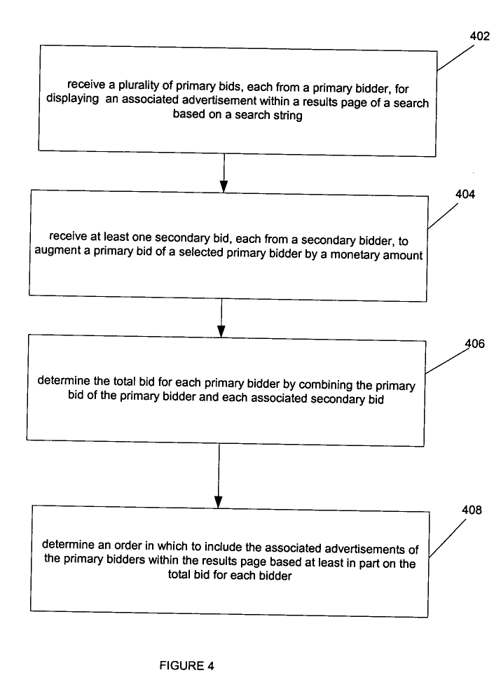

Referring now to FIG. 4 of the drawings, there is shown a flowchart of operations performed by the system 500 of FIG. 5, in accordance with one embodiment of the invention. The operations commence at block 402 wherein the system 500 receives a plurality of primary bids, each from a primary bidder, for displaying an associated advertisement within a results page of a search based on a search string. Thereafter, at block 404, the system 500 receives at least one secondary bid, each from a secondary bidder to augment a primary bid of a selected primary bidder by a monetary amount. At block 406, the system 500 determines the total bid for each primary bid by combining the primary bid of the primary bidder and each associated secondary bid. Thereafter, at block 408, the system 500 determines an order in which to include the associated advertisements of the primary bidders within the results page based at least in part on the total bid for each bidder. In some cases, the system 500 determines the order based on the amount of the total bid as well as a frequency (i.e., the so called click-through rate) with which the associated advertisements of the primary bidders have been selected by end users.

Referring to FIG. 5 of the drawings, reference numeral 500 generally indicates a system that may be used to practice embodiments of the present invention. The system 500 typically includes at least one processor 502 coupled to a memory 504. The processor 502 may represent one or more processors (e.g. microprocessors), and the memory 504 may represent random access memory (RAM) devices comprising a main storage of the system 500, as well as any supplemental levels of memory e.g., cache memories, non-volatile or back-up memories (e.g. programmable or flash memories), read-only memories, etc. In addition, the memory 504 may be considered to include memory storage physically located elsewhere in the system 500, e.g. any cache memory in the processor 502, as well as any storage capacity used as a virtual memory, e.g., as stored on a mass storage device 510.

The system 500 also typically receives a number of inputs and outputs for communicating information externally. For interface with a user or operator, the system 500 may include one or more user input devices 506 (e.g., a keyboard, a mouse, etc.) and a display 508 (e.g., a Cathode Ray Tube (CRT) monitor, a Liquid Crystal Display (LCD) panel).

For additional storage, the system 500 may also include one or more mass storage devices 510, e.g., a floppy or other removable disk drive, a hard disk drive, a Direct Access Storage Device (DASD), an optical drive (e.g. a Compact Disk (CD) drive, a Digital Versatile Disk (DVD) drive, etc.) and/or a tape drive, among others. Furthermore, the system 500 may include an interface with one or more networks 512 (e.g., a Local Area Network (LAN), a WAN, a wireless network, and/or the Internet among others) to permit the communication of information with other computers coupled to the networks. It should be appreciated that the system 500 typically includes suitable analog and/or digital interfaces between the processor 502 and each of the components 504, 506, 508 and 512 as is well known in the art.

The system 500 operates under the control of an operating system 514, and executes various computer software applications 516, components, programs, objects, modules, etc. (e.g. a program or module which performs operations as shown in FIGS. 1 to 4 of the drawings). Moreover, various applications, components, programs, objects, etc. may also execute on one or more processors in another computer coupled to the system 500 via a network 512, e.g. in a distributed computing environment, whereby the processing required to implement the functions of a computer program may be allocated to multiple computers over a network.

In general, the routines executed to implement the embodiments of the invention may be implemented as part of an operating system or a specific application, component, program, object, module or sequence of instructions referred to as “computer programs”. The computer programs typically comprise one or more instructions set at various times in various memory and storage devices in a computer, and that, when read and executed by one or more processors in a computer, cause the computer to perform these steps necessary to execute steps or elements involving the various aspects of the invention. Moreover, while the invention has been described in the context of fully functioning computers and computer systems, those skilled in the art will appreciate that the various embodiments of the invention are capable of being distributed as a program product in a variety of form, and that the invention applies equally regardless of the particular type of signal bearing media used to actually off the distribution. Examples of signal bearing media include but are not limited to recordable type media such as volatile and non-volatile memory devices, floppy and other removable disks, hard disk drives, optical disks (e.g. CD ROMS, DVDs, etc.), among others, and transmission type media such as digital and analog communication links.

It should be borne in mind that the techniques described herein are applicable generally to any type of online auction. For example, according to the techniques described herein, a group of people may each contribute to a bid for a piece of land being auctioned online, say on eBay, or friends and relatives may each contribute to a bid for an expensive Christmas gift for someone in an online auction.

Although the present invention has been described with reference to specific exemplary embodiments, it will be evident that the various modification and changes can be made to these embodiments without departing from the broader spirit of the invention as set forth in the claims. Accordingly, the specification and drawings are to be regarded in an illustrative sense rather than in a restrictive sense. specification and drawings are to be regarded in an illustrative sense rather than in a restrictive sense.

1. A method, comprising:
allowing primary bidders to each place a primary bid for displaying an associated advertisement within a results page of a search based on a search string; and
allowing a secondary bidder to selectively place a secondary bid to augment the primary bid of a primary bidder by a monetary amount.

2. The method of claim 1, wherein the primary bid is expressed as a price-per-action that the primary bidder is willing to pay for a particular action.

3. The method of claim 1, wherein the particular action is selected from the group consisting of a cost-per-acquisition, a cost-per-lead, and a cost-per-click.

4. The method of claim 1, further comprising allowing more than one secondary bidder to selectively place a secondary bid to augment the primary bid of the primary bidder.

5. The method of claim 4, further comprising determining an order in which the associated advertisement of each primary bidder is to be displayed on the results page is based on a combination of the primary bidder and each secondary bid associated therewith.

6. The method of claim 1, wherein each secondary bid augments the primary bid only for a defined time period.

7. A method, comprising:
receiving a plurality of primary bids, each from a primary bidder, for displaying an associated advertisement within a results page of a search based on a search string;
receiving at least one secondary bid, each from a secondary bidder, to augment a primary bid of a selected primary bidder by a monetary amount;
determining the total bid for each primary bidder by combining the primary bid of the primary bidder and each associated secondary bid; and
determining an order in which to include the associated advertisements of the primary bidders within the results page based at least in part on the total bid for the primary bidder.

8. The method of claim 7, wherein the primary bids are expressed as a price-per-action that each primary bidder is willing to pay for a particular action.

9. The method of claim 8, wherein the particular action is selected from the group consisting of a cost-per-acquisition, a cost-per-lead, and a cost-per-click.

10. The method of claim 7, wherein determining the order is also based on an indication of how frequently the associated advertisement is viewed by a person performing the search.

11. The method of claim 7, further comprising receiving more than one secondary bid.

12. The method of claim 7, wherein each secondary bid comprises a temporal component that specifies a time period for which the selected primary bid is to be augmented.

13. A computer-readable medium, having stored thereon a sequence of instructions which when executed by a computer, cause the computer to perform a method, comprising:
allowing primary bidders to each place a primary bid for displaying an associated advertisement within a results page of a search based on a search string; and
allowing a secondary bidder to selectively place a secondary bid to augment the primary bid of a primary bidder by a monetary amount.

14. The computer-readable medium of claim 13, wherein the primary bid is expressed as a price-per-action that the primary bidder is willing to pay for a particular action.

15. The method of claim 14, wherein the particular action is selected from the group consisting of a cost-per-acquisition, a cost-per-lead, and a cost-per-click.

16. A computer-readable medium having stored there on a sequence of instructions which when executed by a computer, cause the computer to perform a method, comprising:
receiving a plurality of primary bids, each from a primary bidder, for displaying an associated advertisement within a results page of a search based on a search string;
receiving at least one secondary bid, each from a secondary bidder, to augment a primary bid of a selected primary bidder by a monetary amount;
determining the total bid for each primary bidder by combining the primary bid of the primary bidder and each associated secondary bid; and
determining an order in which to include the associated advertisements of the primary bidders within the results page based at least in part on the total bid for the primary bidder.

17. The computer-readable medium of claim 16, wherein the primary bids are expressed as a price-per-action that each primary bidder is willing to pay a particular action.

18. The method of claim 17, wherein the particular action is selected from the group consisting of a cost-per-acquisition, a cost-per-lead, and a cost-per-click.

19. A system, comprising:
a processor; and
a memory coupled to the processor, the memory storing instructions which when executed by the processor cause the processor to perform a method, comprising:
allowing primary bidders to each place a primary bid for displaying an associated advertisement within a results page of a search based on a search string; and
allowing a secondary bidder to selectively place a secondary bid to augment the primary bid of a primary bidder by a monetary amount.

20. The system of claim 19, wherein the primary bid is expressed as a price- per-action that the primary bidder is willing to pay for a particular action.

21. The method of claim 20, wherein the particular action is selected from the group consisting of a cost-per-acquisition, a cost-per-lead, and a cost-per-click.

22. A system, comprising:
a processor; and
a memory coupled to the processor, the memory storing instructions which when executed by the processor cause the processor to perform a method, comprising: receiving a plurality of primary bids, each from a primary bidder, for displaying an associated advertisement within a results page of a search based on a search string;
receiving at least one secondary bid, each from a secondary bidder, to augment a primary bid of a selected primary bidder by a monetary amount;
determining the total bid for each primary bidder by combining the primary bid of the primary bidder and each associated secondary bid; and
determining an order in which to include the associated advertisements of the primary bidders within the results page based at least in part on the total bid for the primary bidder.

23. The system of claim 22, wherein the primary bids are expressed as a price-per-action that each primary bidder is willing to pay for a particular action.

24. The method of claim 23, wherein the particular action is selected from the group consisting of a cost-per-acquisition, a cost-per-lead, and a cost-per-click.

25. The system of claim 22, wherein determining the order is also based on an indication of how frequently the associated advertisement is viewed by a person performing the search.

26. The system of claim 22, further comprising receiving more than one secondary bid.
